(19) United States
(12) Patent Application Publication
(10) Pub. No.: US 2011/0308872 A1
(43) Pub. Date: Dec. 22, 2011

(54) CLUTCH MECHANISM FOR MOTORIZED BICYCLE

(76) Inventor: David Eric Bright, Reading, PA (US)

(21) Appl. No.: 12/820,038

(22) Filed: Jun. 21, 2010

(51) Int. Cl. B62K 11/00

(52) U.S. Cl. 180/206.8

(57) ABSTRACT

A clutch mechanism for a motorized bicycle includes: a motor-assisted power source; a pedaling-assisted power source; a clutch that holds the motor-assisted power source away from the wheel so as not to encumber the pedaling-assisted power source. The clutch engages the wheel with a roller gear for either motor-assisted or independent power. A second concave V-shaped roller drive slips over the first concave V-shaped roller to increase the speed of the vehicle.

### BRIEF DESCRIPTION OF THE DRAWINGS

FIG. 1 depicts a side view of an embodiment of the present invention;

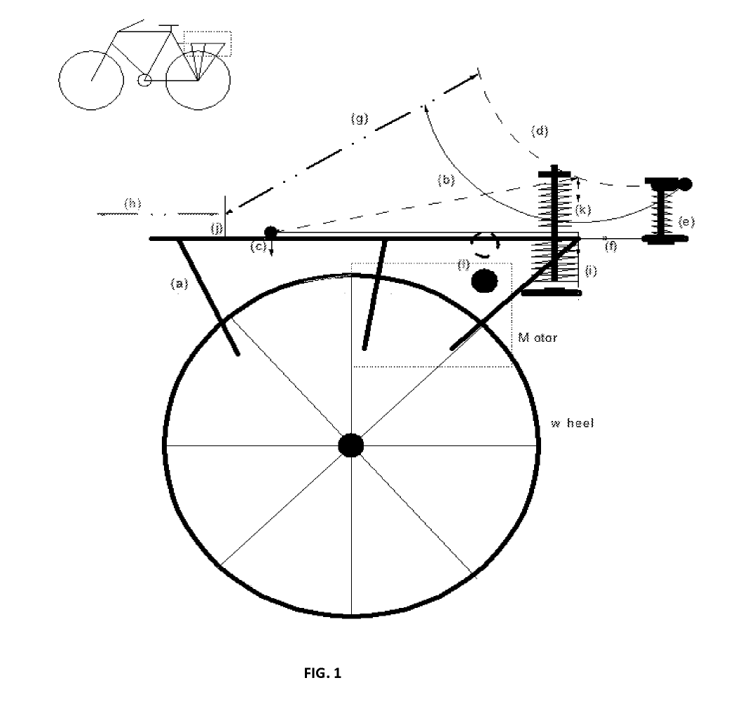

FIG. 2 depicts a top view of an embodiment of the present invention; and

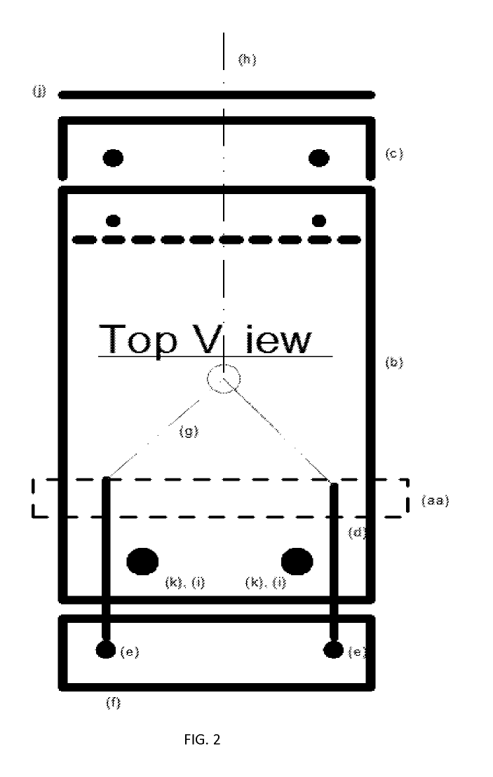

FIG. 3 depicts a drive shaft according to an embodiment of the present invention.

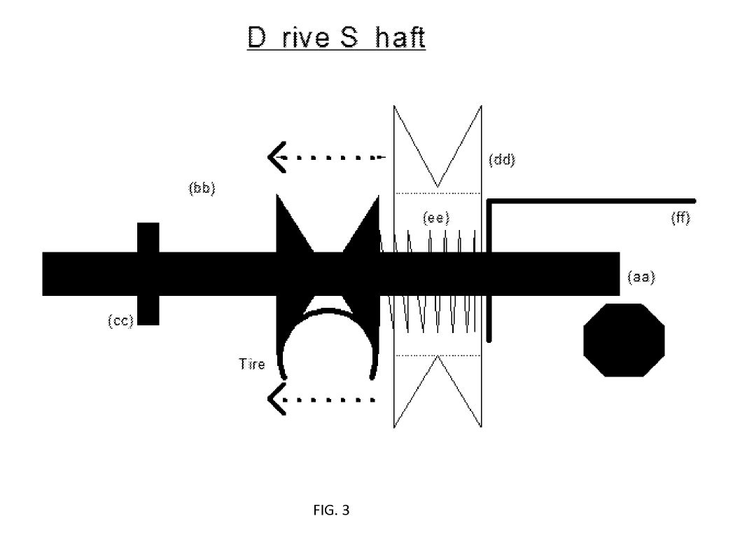

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features. However, any single inventive feature may not address any of the problems discussed above or may only address one of the problems discussed above. Further, one or more of the problems discussed above may not be fully addressed by any of the features described below.

Broadly, an embodiment of the present invention generally provides to a drive/clutch/gear mechanism for a motorized bicycle.

Motorized bicycles have been around for many years and take a variety of forms. Some are friction-driven through a contact roller (drive) contacting either the front or rear wheel to propel the vehicle. Some newer versions have a drive train that consists of an independent sprocket/chain system or sprocket/cog belt with power transmitted from the engine via a centrifugal clutch system. All motorized bicycles share a common trait. In order to be considered a motorized bicycle or motor assisted bicycle, the driven train employed by the motor must be completely independent of the alternate source of power; in most cases this mean pedals and the chain-driven sprockets.

An embodiment of the present invention may be called “the Flutter Drive System.” It is a combination drive, clutching system and roller (gear) mechanism to be used on a motor-assisted bicycle or similar vehicle that works independently, or in coordination, with power supplied from pedaling that eliminates some of the inadequacies of current systems and increases the efficiency and utility of a motorized or motor-assisted bicycle. An embodiment provides an efficient mechanism to transfer maximum horsepower and torque to the tire of a motor-assisted bicycle. The concave “V” design of the roller drive decreases slippage on the tire while decreasing the amount of downward pressure needed on the tire to engage the mechanism.

An embodiment of the invention may include the following:

(a) Fixed engine/accessory mount—serves as a base for the mechanism. Provides a stable mount that is anchored to the wheel and bicycle frame.

(b) Pivoting engine/accessory clutching mount—provides a pivoting (up and down) platform which directly supports the power mechanism, battery and other components.

(c) Pivoting engine/accessory clutching mount hinge—allows the pivoting engine/accessory clutching mount to move up and down at the hinge pivot point.

(d) Clutch engagement eccentrics/levers—provide downward pressure, via a cabling system, to the drive mechanism to engage the drive roller (gear) to the tire.

(e) Clutch engagement eccentric/lever bolt (CEE) and spring assembly—attaches the CEE to the CEE mounting plate.

(f) Clutch engagement eccentric/lever mounting plate—attaches the CEE assembly to the fixed engine/accessory mount.

(g) Clutch engagement eccentric/lever activator cable—engages the drive system through cable pressure emanating from the clutch hand lever.

(h) Clutch hand lever cable—steel cable connecting the hand lever to the CEE cable(s) used to engage the clutch from pressure exerted on the hand lever located on the handle bars.

(i) Clutch return springs—springs used to disengage the clutch absent of pressure exerted through the clutch eccentrics/levers.

(j) clutch cable mounting plate—creates a stable, fixed mounting point for the clutch hand lever cable.

(k) Clutch stabilization and adjusting spring assembly—when clutch is disengaged, provides stabilization and vibration reduction. Also allows for clutch adjustment.

(l) Drive/gear/roller shaft—transfers power from the engine to the wheel after engagement from the clutch assembly. Aside from the main “V-shaped” roller assembly used as the primary drive, the shaft contains a “cover v-shaped roller” that, when engaged changes the gear ratio. A chain sprocket is also welded onto the shaft. This provides a chain hookup to the wheel as an emergency in case the main roller(s) fails due to mechanical problems or poor weather conditions.

An embodiment includes all the mounting items and the following clutch items:

Clutch:
a) Fixed engine/accessory mount
b) Pivoting engine/accessory mount
c) Pivoting engine/accessory mount hinge
d) Clutch engagement eccentrics/levers
e) Clutch engagement eccentric/lever mounting plate
g) Clutch engagement eccentric/lever activator cable
h) Cable from (g) to lever on handle bars
i) Clutch return springs

An alternate embodiment includes optional clutch items:
(j) Clutch cable mounting plate
(k) Clutch adjusting springs

An embodiment includes the following drive items:
(aa) NonCylindrical drive shaft (my example portrays an octagonal shaft)
(bb) V-shaped primary drive roller An alternate embodiment includes optional drive items:
(cc) Chain sprocket
(dd) Secondary drive (speed) roller
(ee) Secondary roller return spring
(ff) Secondary roller actuator fork

An embodiment of the invention creates a robust power transmission system for a motorized vehicle that allows the vehicle, in this case a bicycle, to independently employ two distinct modes of powered motion, namely physical exertion through pedaling and powered motion through a motor and drive shaft.

In an embodiment, the clutch holds the motor powered aspects of the system away from the wheel for complete, unencumbered motion through pedaling. The clutch, through pressure exerted from the hand lever and cable, engages the drive mechanism onto the tire for motor-assisted or independent power.

The drive shaft of an embodiment of the invention employs a V-shaped drive roller which creates more of a friction surface with less clutch pressure. A speed gear, larger in diameter to the main drive roller, provides more speed potential. It is engaged via a clutch fork and returns to its original state via a return spring and the release of downward pressure from the clutch system.

In an embodiment, a chain sprocket is also incorporated onto the shaft. It serves as an emergency drive system should the main drive roller fail or weather conditions prohibit the efficient use of a friction drive system. The sprocket can be quickly connected to a sprocket on the wheel with a quick-attach chain providing chain-driven power to the wheel.

An embodiment of the invention allows a vehicle, in this case a bicycle, to employ 2 independent power sources. A user would ride the bike and employ an embodiment of the invention to either 1) make pedaling easier 2) stop pedaling or use the motor solely to power the bike 3) employ the motor in conjunction with pedaling to climb inclines that are un-climbable through pedaling alone.

When the user wants to employ an embodiment of the invention, he can either press the starter button located near the handle bars or squeeze the clutch lever. In motion, with the clutch lever depressed, the motor will be “kick started”.

In an embodiment, once running, the user can engage or disengage the motor by squeezing and releasing the clutch lever located on the handle bars. If the user needs more speed potential and less low-end torque, with the clutch disengaged, the user will use the clutch fork to slide the speed roller into place. Downward pressure from the clutch lever will then hold the speed roller in place and the speed roller becomes active. Releasing the clutch lever returns the speed gear to its inactive state.

In cases of main roller failure or poor weather conditions which make friction-drive systems impractical, the user can quickly lock the clutch into the engaged position, attached a chain to the chain sprockets located on the drive shaft and wheel, lock the clutch in the upright position (normally disengaged with friction drive), kick start the motor and proceed. Locking the moveable clutch tightens the chain and allows for safe riding. The chain is easily removed by releasing the chain tension by lowering the clutch drive (normally the engaged position).

An embodiment of the invention can be made by machining using equipment such as a drill press, lathe and brake.

To use an embodiment, a user could ride the bike and employ an embodiment of the invention to either 1) make pedaling easier 2) stop pedaling or use the motor solely to power the bike 3) employ the motor in conjunction with pedaling to climb inclines that are un-climbable through pedaling alone.

When the user wants to employ an embodiment of the invention, he can either press the starter button located near the handle bars or squeeze the clutch lever. In motion, with the clutch lever depressed, the motor will be “kick started”.

Once running, the user can engage or disengage the motor by squeezing and releasing the clutch lever located on the handle bars. If the user needs more speed potential and less low-end torque, with the clutch disengaged, the user will use the clutch fork to slide the speed roller into place. Downward pressure from the clutch lever will then hold the speed roller in place and the speed roller becomes active. Releasing the clutch lever returns the speed gear to its inactive state.

An embodiment of the invention can used on any type of motorized equipment or vehicle which requires a completely disjointed secondary power source that can be quickly and effectively activated and de-activated through normal hand pressure.

An embodiment of the invention is an improvement to current systems because:

1) It increases torque by eliminating centrifugal clutch used on many current drive systems

2) It allows the rider to completely disengage the drive mechanism and ride the bike normally with no drag from the motorized drive system

3) The unique design of the Drive/Clutch/Gear Mechanism allows the rider to engage larger rollers which increase the potential speed of the bike; without dismounting the bicycle.

4) The unique concave “V” design of the roller gear differs from current friction drives that employ flat cylindrical roller gears.

inadequacies of current drive mechanisms used on motor-assisted bicycles include the following:

a) Many friction drive systems employ a mounting system that requires the roller (drive gear) maintain constant pressure on the tire with no easy method (dislodge/release) the roller pressure. This prevents the rider from completely disengaging the motorized system and riding the bicycle independent of the motorized drive system (free-wheeling).

b) Most friction drive systems and chain/cog driven systems employ a centrifugal clutch to transmit power from the engine to the drive wheel. Not only do centrifugal clutch reduce the horsepower transmitted to the wheel, they are prone to slippage and are unable to transfer high torque requirements.

c) Chain/cog driven systems never achieve true free-wheeling as, even when disengaged, the sprockets, chain (belt for cog systems), and clutch continue to rotate with power supplied through pedaling.

d) When engaged and powering the bicycle, permanently clamped down friction drive systems and chain/cog driven systems are unable to change gear ratios; or increase engine horsepower and torque through alternately engaging and disengaging the power train. (Often called feathering the clutch)

e) Friction-drive systems routinely use a cylindrical roller made of steel with small serrations or notches in the outer skin to increase tire grip. These systems often require a great deal of constant pressure being exerted on the tire and rim. This can lead to premature failure of either or both.

It should be understood, of course, that the foregoing relates to exemplary embodiments of the invention and that modifications may be made without departing from the spirit and scope of the invention as set forth in the following claims.

We claim:

1. A device for a vehicle with a wheel, comprising:
a motor-assisted power source;
a pedaling-assisted power source;
a clutch that holds the motor-assisted power source away from the wheel so as not to encumber the pedaling-assisted power source; and
a first concave V-shaped roller drive;
wherein the clutch engages the wheel with the first concave roller drive for either motor-assisted or independent power.

2. The device of claim 1, further comprising:
a second concave V-shaped roller drive that slips over the first concave V-shaped roller to increase the speed of the vehicle.
